(19) United States
(12) Patent Application Publication
(10) Pub. No.: US 2006/0007014 A1
(43) Pub. Date: Jan. 12, 2006

(54) Video remote control

(76) Inventor: Sam Stephen Orlando, Bloomfield Hills, MI (US)

Correspondence Address: Sam S. Orlando, 255 Alice Ave., Bloomfield Hills, MI, 48302, US

(21) Appl. No.: 10/885,432

(22) Filed: Jul. 6, 2004

(51) Int. Cl. G08C 19/00

(52) U.S. Cl. 340/825.69; 340/825.72; 348/734; 341/175; 341/176

(57) ABSTRACT

An appliance remote control (10), with a video display (12), control buttons (14), with each control button having a staged depressable switch. The appliance remote control is for any remote controlled appliance such as a TV, VCR, or DVD with the addition of a video display, staged switching for each button, and internal control logic. A person will now have the flexibility to view remote control buttons clearly under otherwise poor visible conditions, and decide if the function of the button is to be selected or not. Touching or slightly depressing a remote control button (16) will display the control button function on the video display. The control function is not passed to the remote controlled appliance at this time. A preview of the button function will be clearly presented on the video display. For example, if the “2” button is slightly depressed, a large character “2” will be displayed on the video display. Anyone with poor eyesight or in a low lighted room will now be able to verify on the bright clear display if this is the button to be selected. If it is the button to be selected, the button is simply depressed completely (18) for the selection to be completed. The button may also be released for no action to be taken. To further enhance this invention, a preview display of any control button may also be displayed on the remote controlled appliance video display.

### CROSS-REFERENCE TO RELATED APPLICATIONS

Not applicable.

### BACKGROUND

1. Field of Invention

This invention relates to a video display integrated on an appliance remote control, such as a TV, VCR or DVD remote control. This invention will specifically improve viewing of each remote control button function by previewing a button function on the remote control video display prior to actually determining if the button is to be selected.

2. Description of Prior Art

A remote control is a wireless device that remotely controls an appliance such as a TV, VCR or DVD. Remote controls are so popular that they are now standard on most purchased appliances. One of the best examples for the remote control use is to turn a TV on or off, change the volume up or down, and most common, to change channels.

The problem is that most all remote controls have buttons that are very small and hard to read. It is very hard for people with poor eye sight to see the small remote control button text. Even if buttons are a larger size, it is at times hard to see in low light conditions such as at night. Sometimes the remote control itself will get dirty from handling and the text on the buttons or remote control body are hard to read.

The prior art of U.S. Pat. No. 6,496,122 to Jeffrey B. Sampsell, Dec. 17, 2002 is an example of an image display shown on a remote control. The problem is that the image display does not visually display the function of a control button before the user actually selects it.

Another video remote control of prior art is of U.S. Pat. No. 5,523,800 to Walter J. Dudek, Jun. 4, 1996. Although this does have a video display, and it does add functionality of pre-programmed buttons, it does not address the preview of a button prior to selecting it.

The issue with current inventions and prior art is that the visual need to see the button selection prior to selecting it is not addressed. People with poor eyesight or people in low light conditions can not see the buttons on standard remote controls currently manufactured.

### SUMMARY

Accordingly, it is an important object of this invention to provide easy viewing of each remote control button function on a video display prior to deciding if the button is to be selected. This eliminates the uncertainty of selecting the proper remote control button under poor visible conditions.

### OBJECTS AND ADVANTAGES

Several objects and advantages of the present invention are:
(a) To provide a remote control video display for easy viewing of button functions.
(b) To provide an individual preview of each remote control button function on a video display prior to fully depressing the button.
(c) To provide an individual preview of each remote control button function on the remote controlled appliance prior to selecting the button.
(d) To provide each remote control button staged switching where the first stage is the preview of the function and the second stage is the passing of the control function to the remote controlled appliance.

Further objects and advantages are to provide a better means of viewing hard to read button text on a remote control for the many appliances such as a TVs, VCRs or Stereos.

### DRAWING FIGURES

FIG. 1 shows the front view of the video remote control with the video display.

FIG. 2 shows the side view of the video remote control with a function button depressed slightly or touched depicting activation of the first stage for the function button preview.

FIG. 3 shows the side view of the video remote control with a function button depressed fully depicting activation of the second stage passing the function control to the remote controlled appliance.

### REFERENCE NUMERALS IN DRAWINGS

10 Video remote control
12 Video display
14 Control button
16 Control button slightly depressed to activate the first stage
18 Control button fully depressed to activate the second stage

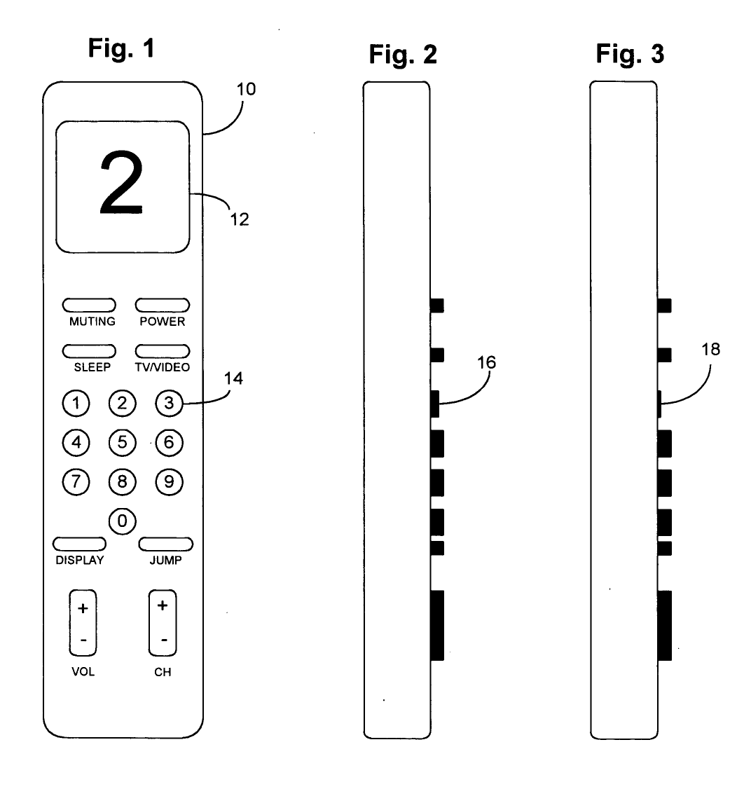

### DESCRIPTION—FIG. 1

A video remote control of the present invention is illustrated in FIG. 1 (front view). The video remote control 10 is shown with video display 12 and a control button 14. The video remote control 10 has many control buttons that provide many select functions. Each control button has a staged switch that allow multiple operations.

### DESCRIPTION—FIG. 2

The video remote control of the present invention is also illustrated in FIG. 2 (side view). The components shown is the control button 16 that is slightly depressed to indicate that the first stage of the switch is activated.

### DESCRIPTION—FIG. 3

The video remote control of the present invention is also illustrated in FIG. 3 (side view). The components shown is the control button 18 that is fully depressed to indicate that the second stage of the switch is activated.

### OPERATION

The video remote control 10 can be used in an identical fashion to that of other remote controls with standard buttons and with no video display. When a control button 14 is fully depressed to activate the second stage 18, the remote control function is passed to the device as in a standard remote control. There is no difference in operation when used as a standard remote control that is shipped with an appliance such as a TV, VCR or DVD. Simply use the proper control button to turn the remotely controlled appliance on or off, change the volume, or change the channel. The difference comes into play on how the control button 14 is used differently. When a control button 14 is touched or slightly depressed, the first stage 16 of the switch is activated. During this first stage a preview of the switch function is displayed on the video display 12. This simple difference in the way the control button 14 is used will display the function of the button on the video display 12 in a greatly enlarged size without passing the function to the remote controlled device. Thus, a person who can not legibly see the button text imprinted on the control button 14 or the video remote control 10 body may legibly preview the buttons function on the video display 12 prior to deciding if it is the proper selection. If a decision is made that this is a proper selection, the control button 14 is fully depressed to activate the second stage 16, or other buttons may be previewed until a proper selection is determined. The larger size of the video display 12 is needed for people with poor eyesight. A lighted or backlit video display 12 will provide enhanced readability for people in low light conditions. Many different types and sizes of displays may be integrated in the video remote control 10. Many different control button technologies may be used to activate switching of different stages such as depression, touch sensor, light, heat etc.. Internal semiconductor circuitry will accomplish the task of processing the different stages of the button switch.

### CONCLUSION, RAMIFICATIONS, AND SCOPE

Thus the reader will see that the video remote control has some very unique advantages over the standard remote control. The operator now has the flexibility to view each remote control button function on the video display clearly under poor visible conditions, and decide if the function of the button is to be selected or not. The scope of this invention is to eliminate the uncertainty of selecting the proper remote control button. All it takes is to touch or slightly depress the button and look at the video display rather than guessing if the correct button is being selected.

I claim:

1) A video remote control having a video display intergraded on said video remote control, and control buttons each having a two stage depressable switch, where the first stage of said two stage depressible switch, presents a preview display of said control button function on said video display, and the second stage of the said two stage depressible switch, passes normal control of said control button to the remote controlled appliance, for the purpose of easy viewing of said remote control button function of said first stage on said video display, prior to a depressed said remote control button of said second stage.

2) The video remote control with said video display of claim 1, where the first stage of said two stage depressible switch, presents a preview display of said control button function on the remote controlled appliance video display, for the purpose of easy viewing of said remote control button function of said first stage on said video display, prior to a depressed said remote control button of said second stage.

3) The video remote control with said video display of claim 1, where the first stage of said two stage depressible switch is touch activated.

4) The video remote control with said video display of claim 1, where the second stage of said two stage depressible switch is delay activated.
